(19) United States
(12) Patent Application Publication
(10) Pub. No.: US 2002/0125187 A1
(43) Pub. Date: Sep. 12, 2002

(54) Pour-through water treatment dispenser

(75) Inventors: John D. Tanner, Plymouth, MN (US); David J. Emmons, Plymouth, MN (US); Johannes N. Gaston, Minnetonka, MN (US); Douglas J. Van Ornum, Minnetonka, MN (US)

Correspondence Address: MERCHANT & GOULD PC, P.O. BOX 2903, MINNEAPOLIS, MN, 55402-0903, US

(73) Assignee: Recovery Engineering, Inc., Minneapolis, MN (US)

(21) Appl. No.: 10/137,179

(22) Filed: Apr. 29, 2002

Related U.S. Application Data
(63) Continuation of application No. 09/005,292, filed on Jan. 9, 1998, now abandoned.

(51) Int. Cl. B01D 35/027; B01D 35/157

(52) U.S. Cl. 210/418; 210/477

(57) ABSTRACT

A pour-through water treatment device. The device is a dispenser comprising a tank, pour tray and cover. The length of the device is more than twice its width. Its height is between 9.0 and about 11.0 inches. The pour tray has a downwardly facing channel into which an upwardly facing edge of the tank is inserted. The pour tray also includes baffles to prevent water from sloshing back and forth.

### FIELD OF THE INVENTION

This invention relates to pour-through water treatment dispensers. In particular, this invention relates to a dispenser having optimum dimensions and shape, a tank/pour tray configuration for better separating treated water from untreated water, and baffles in the pour tray for reducing sloshing in the pour tray as it is being carried.

### BACKGROUND OF THE INVENTION

Domestic water treatment devices are known in the art. Among these devices are self-contained systems which process water in batches. Examples of batch devices are pitchers/carafes and larger dispensers from which treated water is poured through a spigot. These systems typically have upper and lower chambers separated by a filter cartridge. They are called “pour-through” devices because they rely on gravity to force water from the upper chamber, through the cartridge, and into the lower chamber, thereby producing treated water.

One of the shortcomings of pour-through dispensers is that they have not been optimally sized and configured. They tend to be wider than necessary, and less long and tall than they could be, which wastes valuable refrigerator space. Their dimensions and shape also have not been optimized to fit under the faucet in the typical kitchen sink when the pour tray is being filled.

As a result of recent improvements in filter media for pour-through devices, biological contaminants such as protozoan cysts (e.g., cryptosporidium) can now be removed. Successful removal of biological contaminants by the filter cartridge is of no benefit, however, if the treated water becomes contaminated with untreated water. Any contamination is unacceptable because even a small amount of biological contaminant would make all of the treated water unsuitable for drinking.

One way that treated water can become contaminated with untreated water in a pour-through dispenser is when filling the pour tray in the sink. Users often fill dispensers by first turning on the faucet and then moving it over the pour tray. As the water stream passes over the top edges of the tank and pour tray, untreated water can leak between them and into the bottom of the tank.

Another problem with pour-through dispensers results from the large amount of water they contain. Users often carry the dispenser from the sink to the refrigerator (or somewhere else) immediately after filling the pour tray. The untreated water remaining in the pour tray can slosh back and forth, making the dispenser unstable and making water splash out of the pour tray.

What has been needed is a pour-through water treatment dispenser with optimized dimensions and shape, a tank/pour tray arrangement for better separating treated water from untreated water, and a pour-tray configuration which reduces sloshing in the pour tray.

### SUMMARY OF THE INVENTION

In one aspect of the invention, a water treatment dispenser comprises a tank for receiving treated water, a pour tray inserted into the tank, and a cover covering the pour tray. The length of the dispenser is more than twice its width.

In another aspect of the invention, a water treatment dispenser comprises a tank for receiving treated water and a pour tray inserted into the tank. The height of the dispenser is more than 9.0 but less than about 11.0 inches.

In another aspect of the invention, a water treatment dispenser comprises a tank for receiving treated water, a pour tray inserted into the tank, and a cover covering the pour tray. The pour tray has a generally downwardly facing channel around its periphery into which an upwardly facing edge of the tank is inserted.

In another aspect of the invention, a water treatment dispenser comprises a tank for receiving treated water, a pour tray inserted into the tank, and a cover covering the pour tray. The pour tray has a baffle extending inwardly into an interior of the pour tray.

These and other advantages and features of novelty which characterize the invention are pointed out with particularity in the claims annexed hereto. However, for a better understanding of the invention and its advantages, reference should be made to the drawings which form a further part hereof, and to the accompanying descriptive matter in which there is illustrated and described a preferred embodiment of the invention.

### BRIEF DESCRIPTION OF THE DRAWINGS

A preferred embodiment of the present invention will be described with reference to the accompanying drawings, wherein like reference numerals identify corresponding parts:

FIG. 1 is a perspective view of a water treatment device according to the present invention, with the cover removed;

FIG. 2 is a cross-sectional view of the device shown in FIG. 1;

FIG. 3 is a perspective view of a pour-through water treatment dispenser;

FIG. 4 is a front view thereof;

FIG. 5 is a back view thereof;

FIG. 6 is a right view thereof;

FIG. 7 is a left view thereof;

FIG. 8 is a top view thereof;

FIG. 9 is a bottom view thereof;

FIG. 10 is a perspective view of another pour-through water treatment dispenser;

FIG. 11 is a front view thereof;

FIG. 12 is a back view thereof;

FIG. 13 is a right view thereof;

FIG. 14 is a left view thereof;

FIG. 15 is a top view thereof; and

FIG. 16 is a bottom view thereof.

### DETAILED DESCRIPTION OF THE PREFERRED EMBODIMENT

Water treatment device 10 includes tank 20, pour tray 30, lid 40 and filter cartridge 60. Device 10 is used as other pour-through devices. Pour tray 30 is filled with tap water. By the force of gravity, water passes through filter cartridge 60 and into tank 20. In the case of the dispenser arrangement described herein, the user pours treated water out of tank 20 through spigot 50.

Device 10 is sized and configured to make optimum use of the space available in most refrigerators. Because it is long and narrow (more than twice as long as it is wide), it takes up a minimum amount of the front shelf space available while not wasting shelf space behind it. It is also relatively tall, about the height of a milk carton, which further takes advantage of the space available. The specific dimensions of the preferred device are as follows: Height H1 (with cover 40 on) is 10.25 inches; width W is 5.50 inches; and length L is 15.38 inches. These dimensions could be varied within the principles of the invention to make a different sized, but relatively narrow, long and tall dispenser.

Device 10 is also sized and configured to fit in most kitchen sinks. The length dimension L is short enough to fit in the sink diagonally or lengthwise. The narrow width dimension W, and the rounded ends 12 of device 10, make it easier for device 10 to fit diagonally in the sink. The height of device 10 without the cover (H2) must also be low enough so that device 10 will fit under the typical faucet while in the sink. The height H2 in the preferred embodiment is 9.51 inches, but it could be a little higher or lower within the principles of the invention.

Pour tray 30 and tank 20 are configured to prevent untreated water from leaking between pour tray 30 and upper edge 22 of tank 20 when pour tray 30 is being filled or when device 10 is being carried. Pour tray 30 includes lip 37 extending outwardly proximate the top of pour tray 30, and over upper edge 22 of tank 20. Overhanging wall 38 extends downwardly from an outer end of lip 37 and along the outside of upper wall 21 of tank 20. In this way, a downwardly facing channel 36 is formed into which upper edge 22 of upper wall 21 of tank 20 is inserted. It will be understood that the shape and orientation of channel 36 and its location on pour tray 30 could be varied. Overhanging wall 38, while preferred because it helps retain pour tray 30 on tank 20 and helps block untreated water from going into tank 20, is not absolutely necessary. Channel 36 and lip 37 need not be molded as part of pour tray 30, but could be a separate part attached to it. Upper edge 22 of tank 20 also need not be its uppermost edge, but could be positioned lower on tank 20.

Cover 40 is placed on top of device 10 after it has been filled. Cover 40 is retained on pour tray 30 by peripheral wall 42 surrounding retaining wall 39, which extends upwardly from lip 37. The bottom of peripheral wall 42 rests on the upper side of lip 37.

Pour tray 30 includes baffles 33. When device 10 is being carried by finger holds 23 in tank 20 (pour tray 30 has correspondingly shaped ledges 34 resting on tank 20), water remaining in pour tray 30 can slosh back and forth, making the device unstable, and potentially causing water to splash out of pour tray 30. Baffles 33 are provided to prevent this. In the preferred embodiment, they are vertical walls extending perpendicularly from inner sidewalls 35 of pour tray into the interior of pour tray 30. They are positioned opposite one another in the middle of pour tray 30. It will be understood that the number, shape and positioning of the baffles could be varied within the principles of the invention.

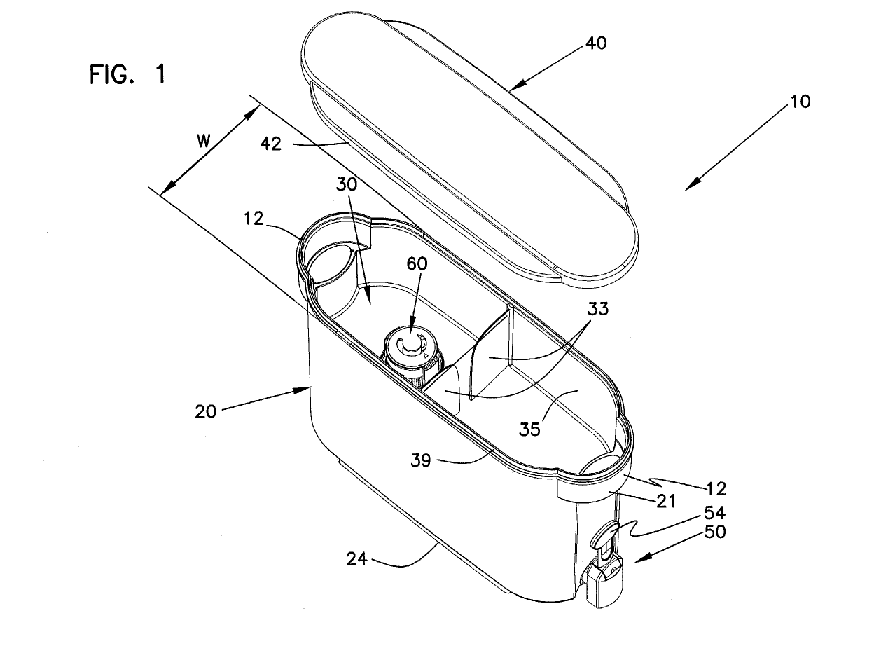

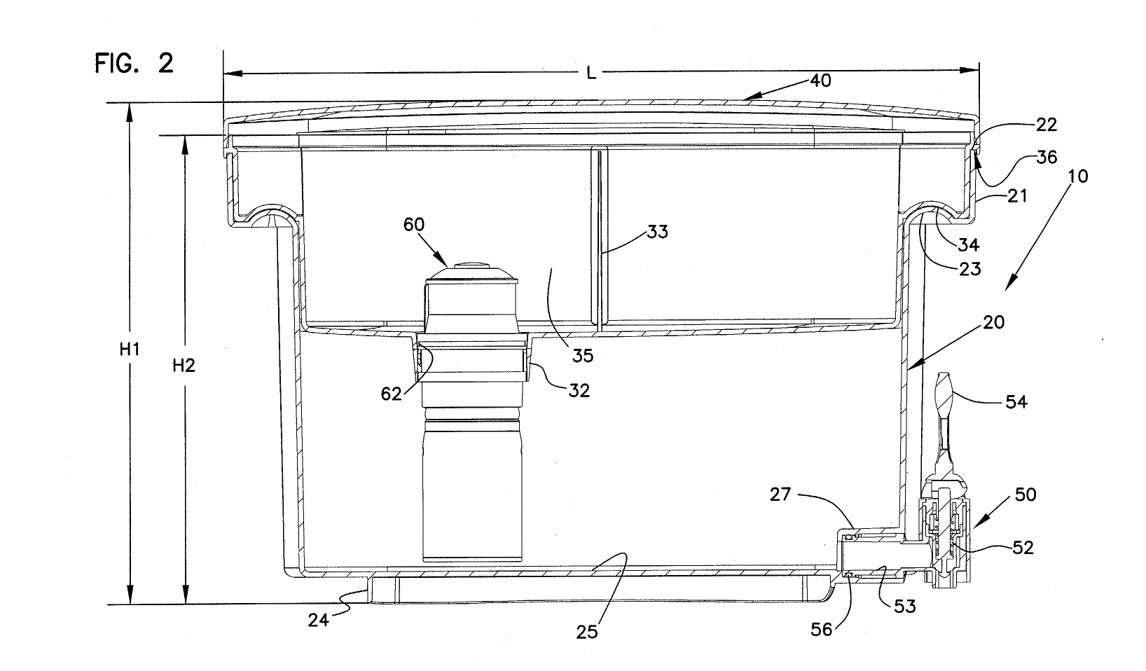

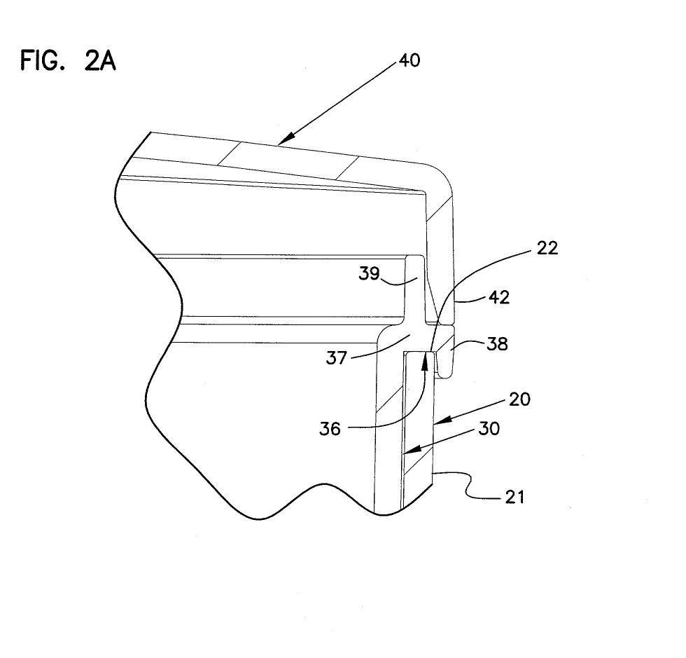

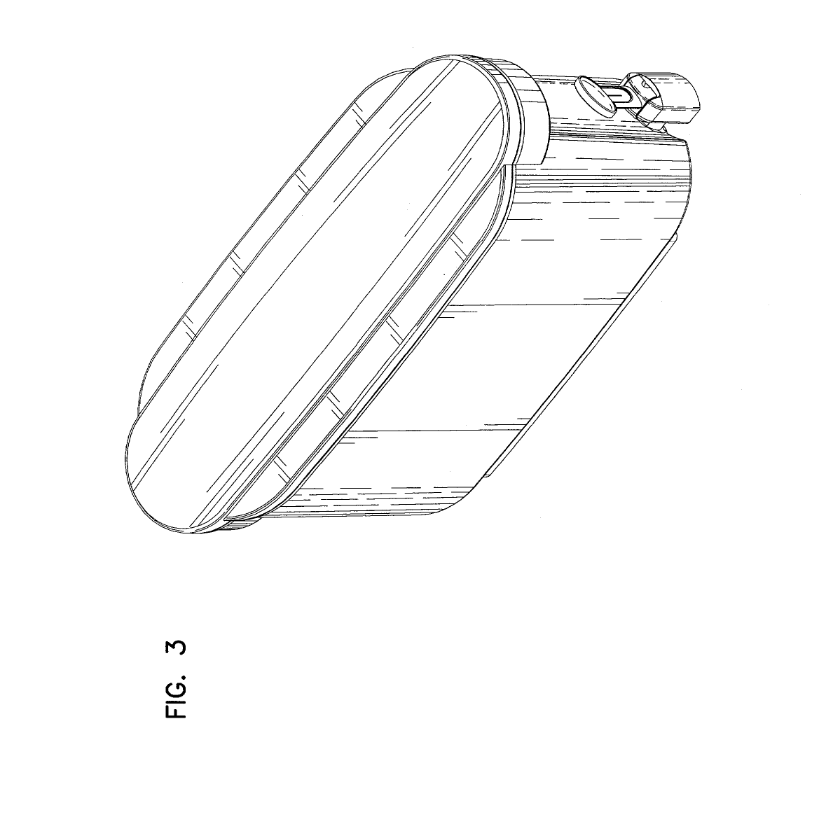

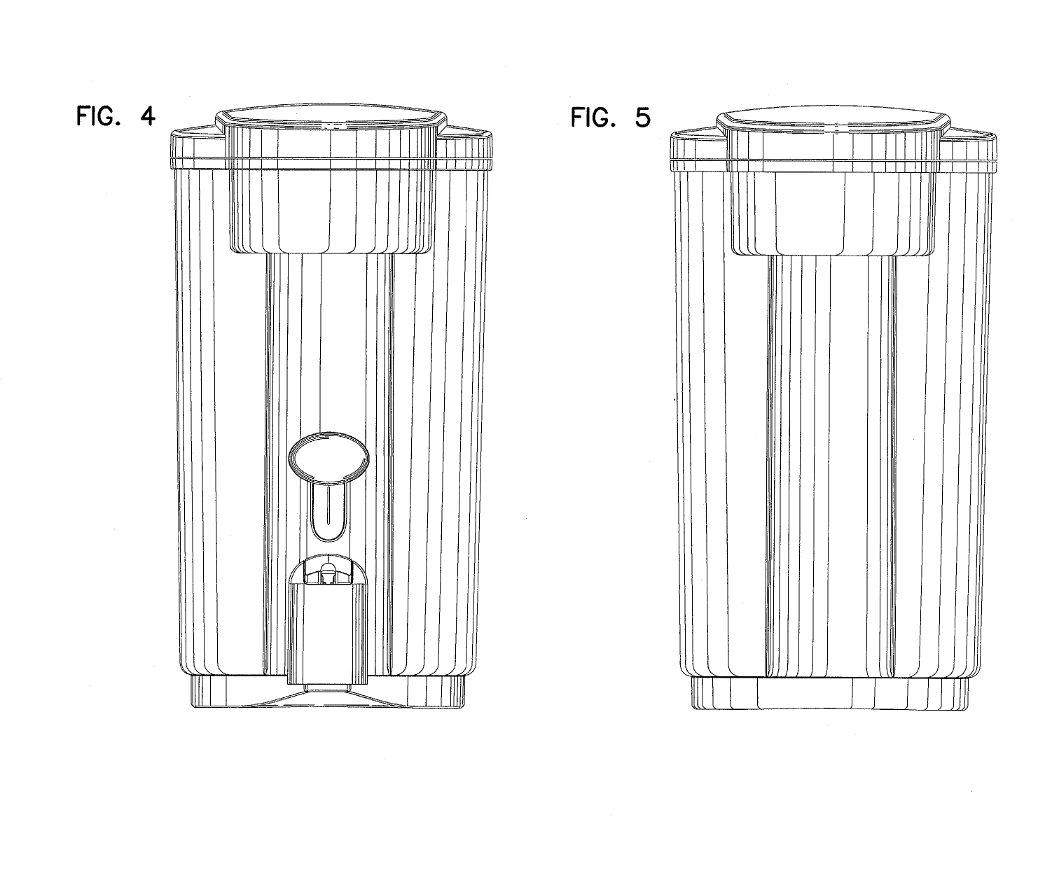

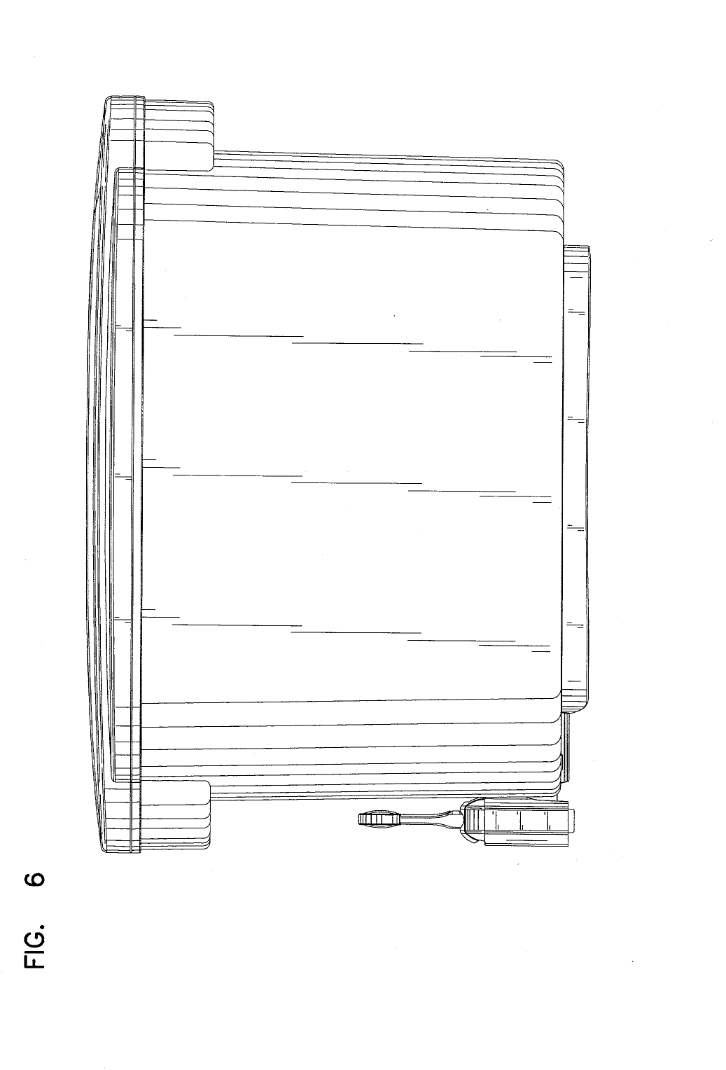

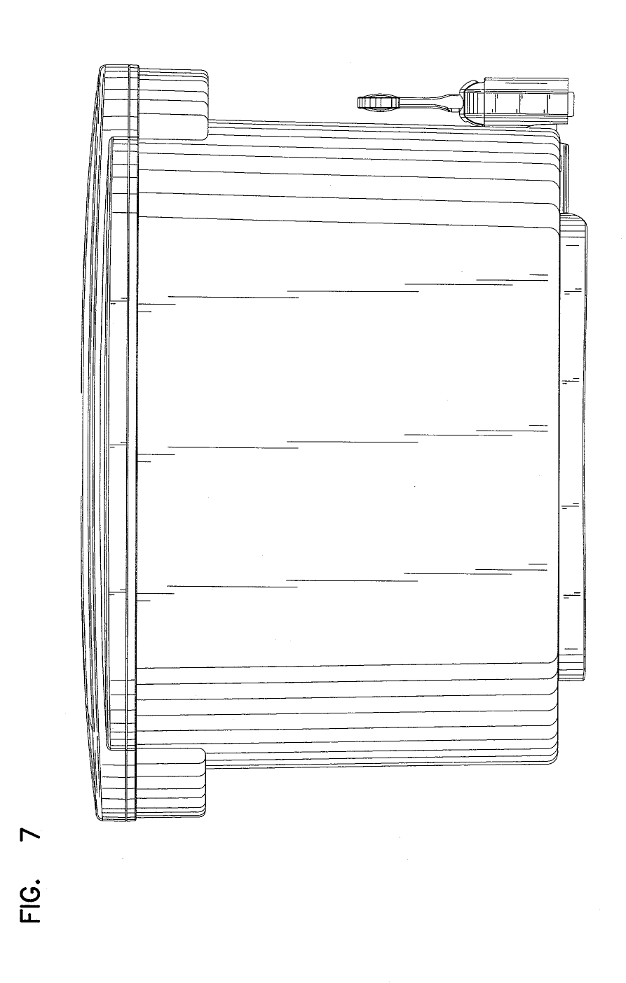

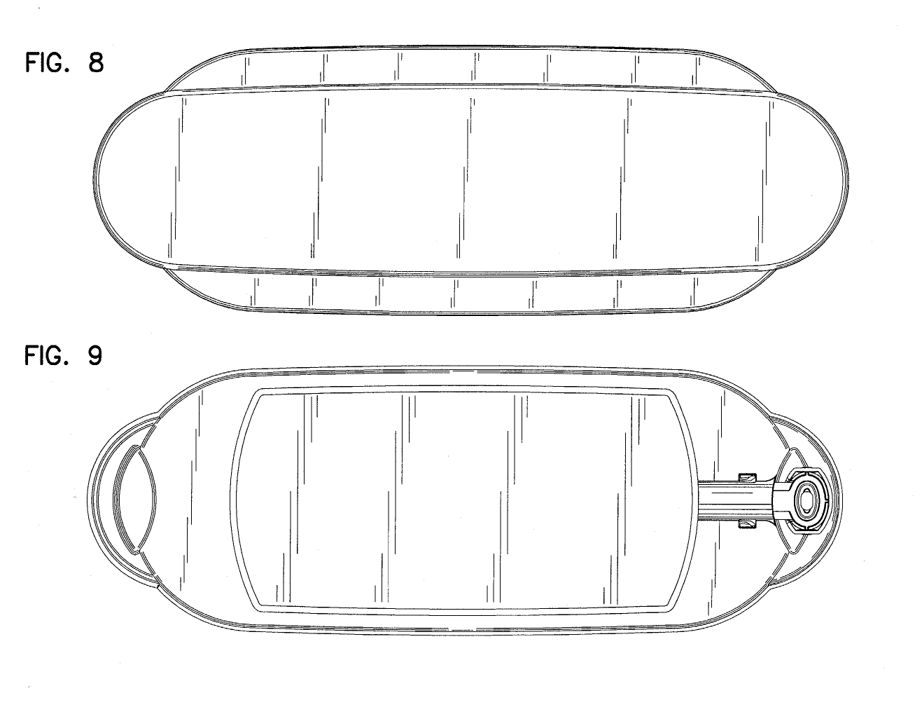

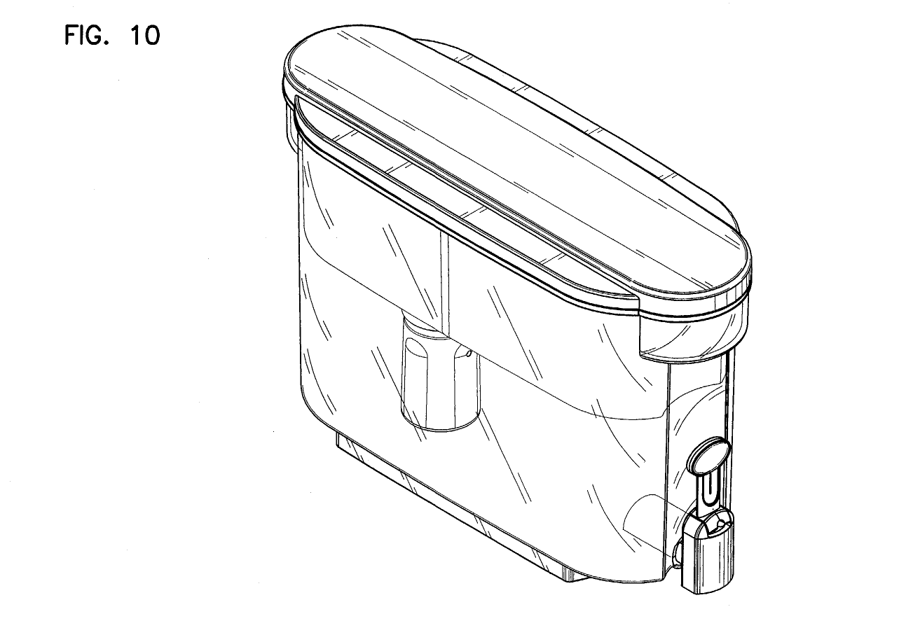

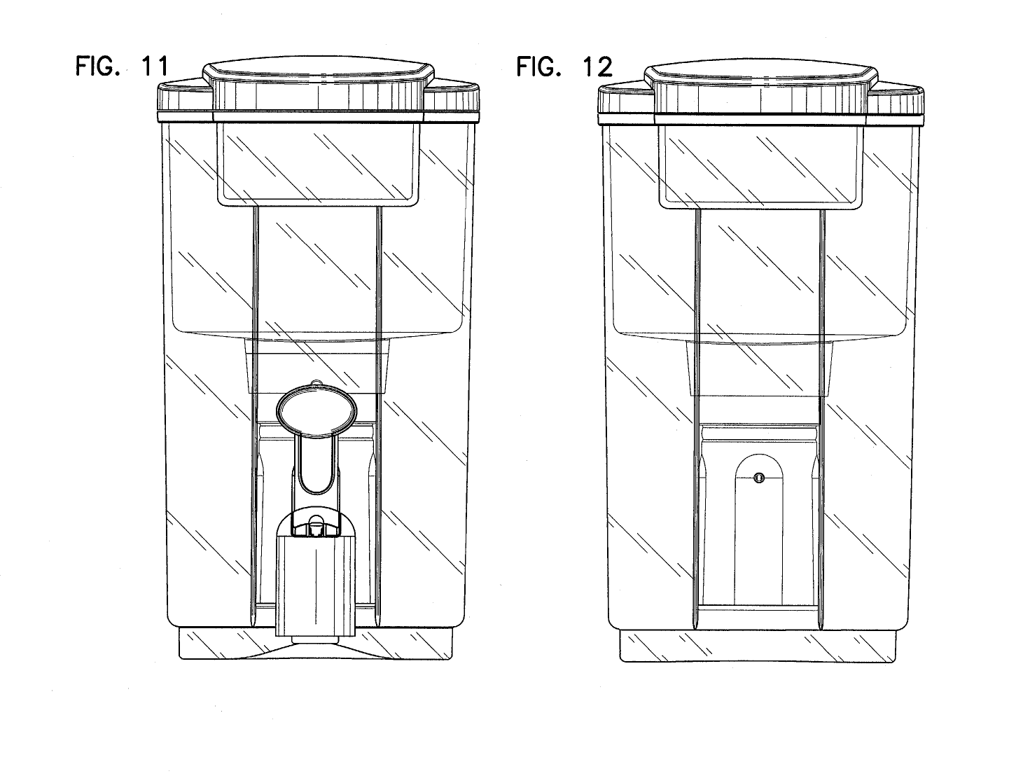

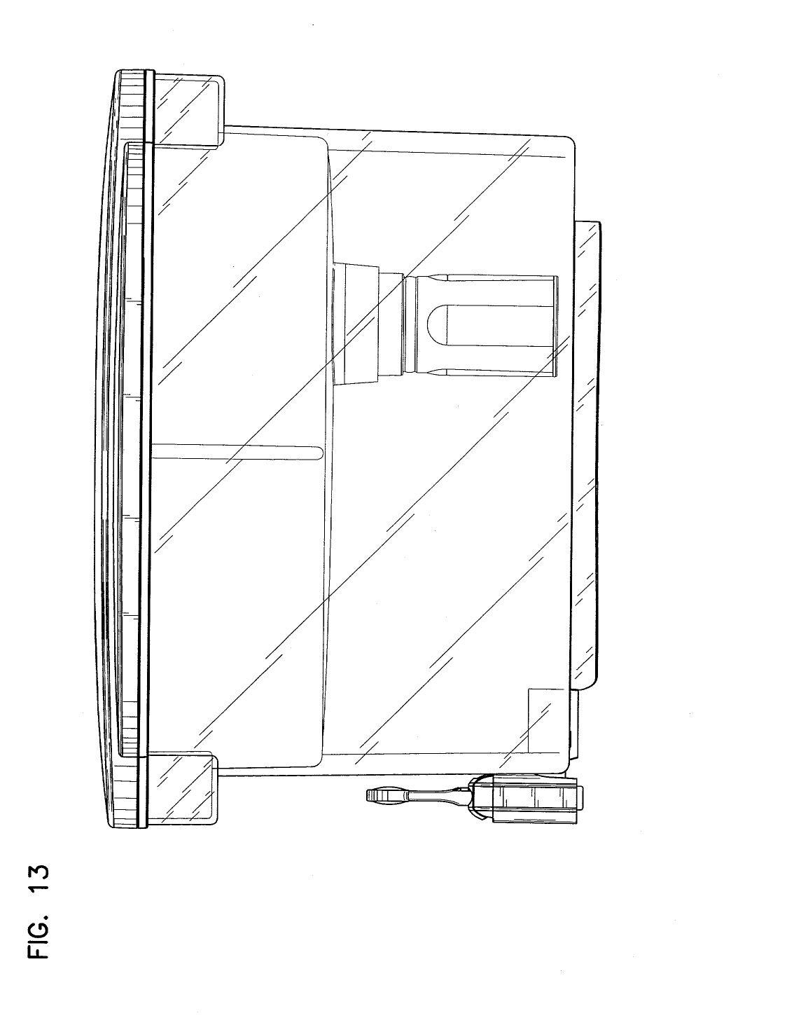

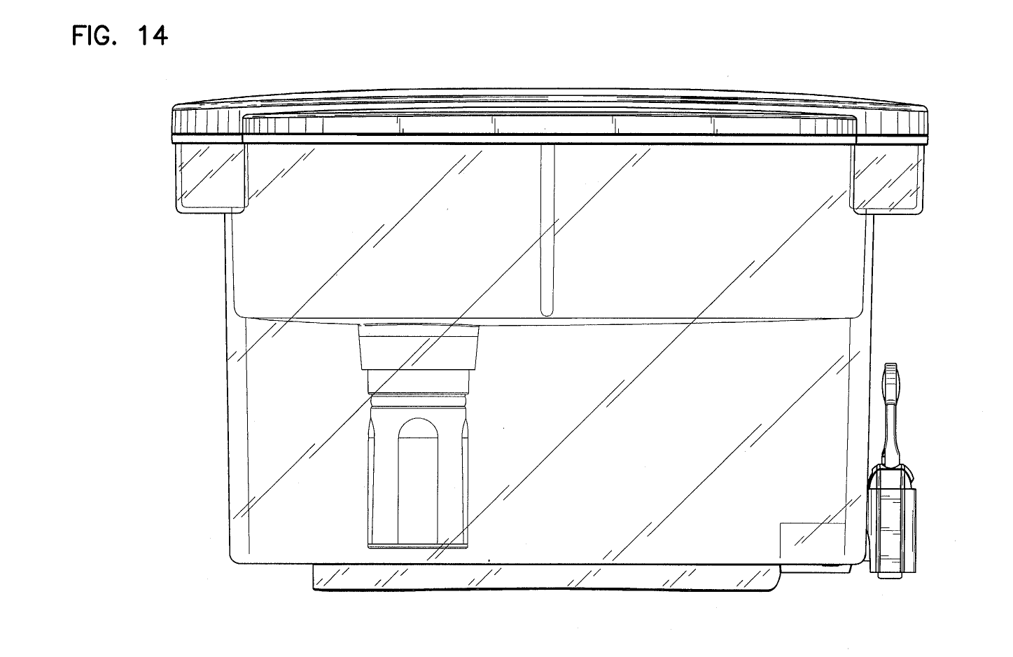

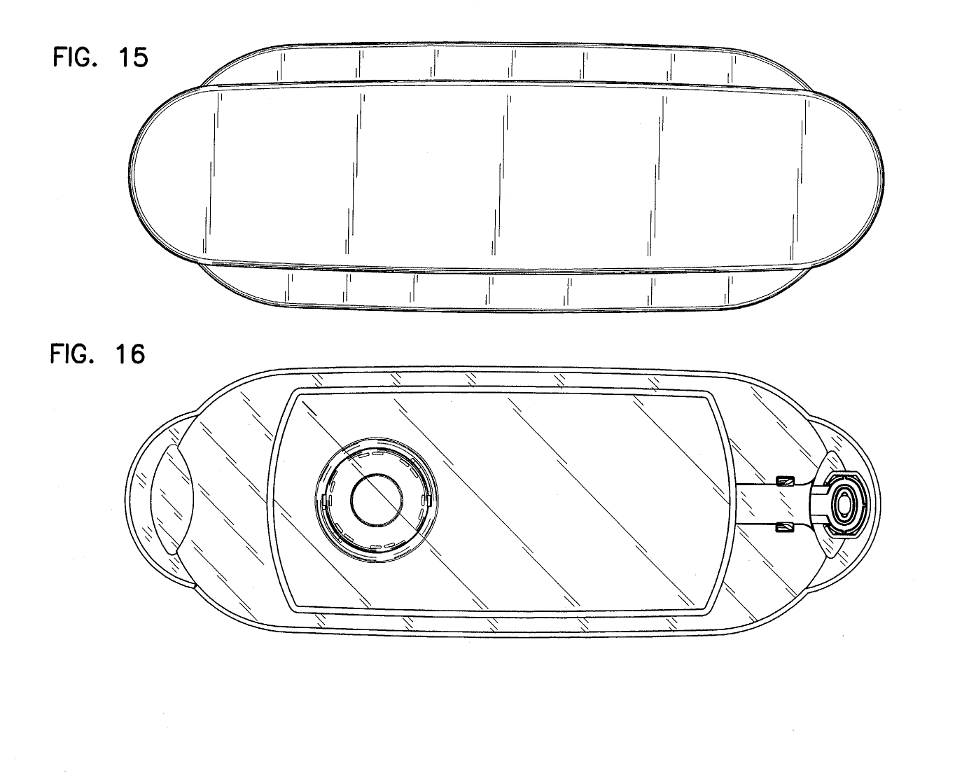

Referring to FIG. 2, pour tray 30 tapers downwardly toward sleeve 32 so that all of the water in pour tray 30 is drained through filter cartridge 60. Similarly, as best seen in FIG. 1, pour tray 30 also tapers downwardly toward its longitudinal center line so that all of the water on the side of baffles 33 opposite filter cartridge 60 is drained to the filter cartridge 60.

Filter cartridge 60 is sealed to sleeve 32 by O-ring 62. It will be understood that a variety of filter cartridges, having a variety of media, could be employed within principles of the invention.

Treated water is poured from tank 20 through spigot 50. Spigot 50 includes valve 52 movable between open and closed positions by lever 54. Spigot 50 is sealed to spigot outlet 27 of tank 20 via O-ring 56. The bottom of spigot outlet 27 and the bottom of valve chamber 53 are placed very low in tank 20, below tank bottom 25, to allow tank 20 to fully drain. Base 24 raises tank 20 up so that the bottom of spigot 50 will not touch the refrigerator shelf or other surface on which device 10 is standing.

It should be understood that the present invention is not limited to the preferred embodiment described above, which is illustrative only. Changes may be made in detail, especially in matters of shape, size, arrangement of parts, or material of components, within the principles of the invention to the full extent indicated by the broad general meanings of the terms in which the appended claims are expressed.

We claim:

1. A water treatment device from which treated water is dispensed through a spigot, comprising a tank for receiving treated water, a pour tray inserted into said tank, and a cover covering said pour tray, with a length of the dispenser being more than twice a width of the dispenser.

2. A water treatment device according to claim 1, wherein said length is more than 14.5 inches.

3. A water treatment device according to claim 1, wherein said width is less than 7.0 inches.

4. A water treatment device according to claim 1, wherein a height of the dispenser is more than 9.0 inches.

5. A water treatment device from which treated water is dispensed through a spigot, comprising a tank for receiving treated water and a pour tray inserted into said tank, with a height of the dispenser being more than 9.0 inches but less than about 11.0 inches.

6. A water treatment device according to claim 5, wherein said height is about 9.5 inches.

7. A water treatment device according to claim 5, wherein a length of the dispenser is more than 14.5 inches but less than about 16.0 inches.

8. A water treatment device according to claim 7, wherein said length is about 15.5 inches.

9. A water treatment device according to claim 7, wherein opposite ends of said tank are rounded.

10. A water treatment device according to claim 5, wherein a width of the dispenser is less than 7.0 inches.

11. A water treatment device from which treated water is dispensed through a spigot, comprising:
(a) a tank for receiving treated water, having an upwardly facing edge;
(b) a pour tray inserted into said tank, said pour tray having a generally downwardly facing channel around its periphery into which said upwardly facing edge of said tank is inserted; and
(c) a cover covering said pour tray.

12. A water treatment device according to claim 11, wherein said channel in said pour tray is formed by a generally horizontal lip extending outwardly from said pour tray proximate an uppermost end, and an overhanging wall extending downwardly from an outer end of said lip.

13. A water treatment device according to claim 11, wherein said channel is molded as part of said pour tray.

14. A water treatment device according to claim 11, wherein said upwardly facing edge of said tank is also an uppermost edge of said tank.

15. A water treatment device according to claim 12, said pour tray further having a cover retaining wall extending upwardly from said lip, a peripheral wall of said cover surrounding said retaining wall of said pour tray.

16. A water treatment device from which treated water is dispensed through a spigot, comprising:
(a) a tank for receiving treated water;
(b) a pour tray inserted into said tank, said pour tray having a baffle extending inwardly into an interior of said pour tray; and
(c) a cover covering said pour tray.

17. A water treatment device according to claim 16, wherein said baffle is positioned proximate a middle of said pour tray.

18. A water treatment device according to claim 16, comprising a plurality of baffles extending inwardly into an interior of said pour tray.

19. A water treatment device according to claim 18, wherein said baffles extend toward one another from opposite sides of said pour tray, leaving a space between them through which water can move.

20. A water treatment device according to claim 16, wherein said baffle is molded as part of said pour tray.

21. A water treatment device according to claim 16, wherein said baffle comprises a generally vertical wall extending generally perpendicularly from an inner wall of said pour tray.
